(19) United States
(12) Patent Application Publication
(10) Pub. No.: US 2026/0313579 A1
(43) Pub. Date: Oct. 8, 2026

(54) REGISTRATION METHOD AND APPARATUS, AND STORAGE MEDIUM AND CHIP

(71) Applicant: Beijing Xiaomi Mobile Software Co., Ltd., Beijing (CN)

(72) Inventor: Jinhua WU, Beijing (CN)

(73) Assignee: Beijing Xiaomi Mobile Software Co., Ltd., Beijing (CN)

(21) Appl. No.: 19/106,337

(22) PCT Filed: Sep. 2, 2022
(86) PCT No.: PCT/CN2022/116898

§ 371 Date: Feb. 25, 2025

(51) Int. Cl. H04W 60/00; H04W 48/16

(52) U.S. Cl. CPC H04W 60/005; H04W 48/16

(57) ABSTRACT

The present disclosure relates to a registration method and apparatus, and a storage medium and a chip. The method comprises: a terminal device sending a first registration request message to a first network function by means of a first access network device, and determining, in response to having received a first registration acceptance message, which is sent by the first network function by means of the first access network device, that the terminal device has been successfully registered with a first communication network, wherein the first registration request message comprises a first parameter, the first parameter is used for representing that the terminal device registers with a plurality of communication networks, the communication networks comprise the first communication network, the first network function is a network function in the first communication network, and the first registration acceptance message is a message sent by the first network function when the first network function determines, according to the first registration request message, that both the terminal device and the first communication network have the capability of supporting the registration of the terminal device with the plurality of communication networks.

### TECHNICAL FIELD

The present disclosure relates to the field of communication technologies, and in particular, to a registration method and apparatus, a storage medium and a chip.

### BACKGROUND

With the development of wireless communication technologies and terminal technologies, the existing wireless communication networks are becoming increasingly complex, and the communication networks support more and more wireless communication standards, such as supporting that the 3rd Generation Mobile Communication Technology (3G) wireless communication networks, the 4th Generation Mobile Communication Technology (4G) wireless communication networks, the 5th Generation Mobile Communication Technology (5G) wireless communication networks can exist simultaneously in the same area, and terminal devices can also have the capability to support multiple wireless communication standards or multiple wireless communication networks.

In the related arts, although the terminal devices have the capability to support the multiple wireless communication networks, it cannot maintain a registration status in two wireless communication networks at the same time.

### SUMMARY

In order to overcome the above problems existing in the related arts, the present disclosure provides a registration method and apparatus, a storage medium and a chip.

According to a first aspect of an embodiment of the present disclosure, there is provided a registration method, which is applied to a terminal device, and the method includes:
sending a first registration request message to a first network function through a first access network device, wherein the first registration request message includes a first parameter, the first parameter is configured to characterize registration of the terminal device with a plurality of communication networks, the communication networks include a first communication network, and the first network function is a network function in the first communication network; and
in response to receiving a first registration acceptance message sent, through the first access network device, by the first network function, determining that the terminal device is successfully registered in the first communication network, wherein the first registration acceptance message is a message sent by the first network function in a case of determining, according to the first registration request message, that the terminal device and the first communication network have a capability to support the terminal device to register in the plurality of communication networks.

According to a second aspect of an embodiment of the present disclosure, there is provided a registration method, which is applied to a first network function, and the method includes:
in response to receiving a first registration request message sent, through a first access network device, by a terminal device, sending a third registration request message to a third network function, wherein the first registration request message and the third registration request message include a first parameter, the first parameter is configured to characterize registration of the terminal device with a plurality of communication networks, the communication networks include a first communication network, the first network function is a network function in the first communication network, and the third network function is a network function that provides a user data management function; and
in response to receiving a third registration acceptance message sent by the third network function, sending a first registration acceptance message to the terminal device through the first access network device.

According to a third aspect of an embodiment of the present disclosure, which is applied to a second network function, the method includes:
in response to receiving a second registration request message sent, through a second access network device, by a terminal device, sending a fourth registration request message to a third network function, wherein the second registration request message and the fourth registration request message include a second parameter, the second parameter is configured to characterize that the terminal device has a capability to register with a plurality of communication networks, the communication networks include a first communication network and a second communication network, and the second network function is a network function in the second communication network; and
in response to receiving a fourth registration acceptance message sent by the third network function, sending a second registration acceptance message to the terminal device through the second access network device.

According to a fourth aspect of an embodiment of the present disclosure, there is provided a registration method, which is applied to a third network function, and the method includes:
in response to receiving a third registration request message sent by a first network function, determining whether a terminal device and a first communication network have a capability to support the terminal device to register in a plurality of communication networks, wherein the third registration request message includes a first parameter, the first parameter is configured to characterize registration of the terminal device with the plurality of communication networks, the communication networks include the first communication network, and the first network function is a network function in the first communication network; and
sending a third registration acceptance message to the first network function in a case of determining that the terminal device and the first communication network have the capability to support the terminal device to register in the plurality of communication networks.

According to a fifth aspect of an embodiment of the present disclosure, there is provided a registration apparatus, and the apparatus includes:
a first sending module, configured to send a first registration request message to a first network function through a first access network device, wherein the first registration request message includes a first parameter, the first parameter is configured to characterize registration of the terminal device with a plurality of communication networks, the communication networks include a first communication network, and the first network function is a network function in the first communication network; and
a first determination module, configured to, in response to receiving a first registration acceptance message sent, through the first access network device, by the first network function, determine that the terminal device is successfully registered in the first communication network, wherein the first registration acceptance message is a message sent by the first network function in a case of determining, according to the first registration request message, that the terminal device and the first communication network have a capability to support the terminal device to register in the plurality of communication networks.

According to a sixth aspect of an embodiment of the present disclosure, there is provided a registration apparatus, which is applied to a first network function, and the apparatus includes:
a second sending module, configured to, in response to receiving a first registration request message sent, through a first access network device, by a terminal device, send a third registration request message to a third network function, wherein the first registration request message and the third registration request message include a first parameter, the first parameter is configured to characterize registration of the terminal device with a plurality of communication networks, the communication networks include a first communication network, the first network function is a network function in the first communication network, and the third network function is a network function that provides a user data management function; and
a third sending module, configured to, in response to receiving a third registration acceptance message sent by the third network function, send a first registration acceptance message to the terminal device through the first access network device.

According to a seventh aspect of an embodiment of the present disclosure, there is provided a registration apparatus, and the apparatus includes:
a fourth sending module, configured to, in response to receiving a second registration request message sent, through a second access network device, by a terminal device, send a fourth registration request message to a third network function, wherein the second registration request message and the fourth registration request message include a second parameter, the second parameter is configured to characterize that the terminal device has a capability to register with a plurality of communication networks, the communication networks include a first communication network and a second communication network, and the second network function is a network function in the second communication network; and
a fifth sending module, configured to, in response to receiving a fourth registration acceptance message sent by the third network function, send a second registration acceptance message to the terminal device through the second access network device.

According to an eighth aspect of an embodiment of the present disclosure, there is provided a registration apparatus, and the apparatus includes:
a second determination module, configured to, in response to receiving a third registration request message sent by a first network function, determine whether a terminal device and a first communication network have a capability to support the terminal device to register in a plurality of communication networks, wherein the third registration request message includes a first parameter, the first parameter is configured to characterize registration of the terminal device with the plurality of communication networks, the communication networks include the first communication network, and the first network function is a network function in the first communication network; and
a sixth sending module, configured to send a third registration acceptance message to the first network function in a case of determining that the terminal device and the first communication network have the capability to support the terminal device to register in the plurality of communication networks.

According to a ninth aspect of an embodiment of the present disclosure, there is provided a registration apparatus, including:
a processor, and
a memory configured to store instructions executable by the processor;
wherein the processor is configured to perform steps of the registration method provided in the first aspect of the present disclosure.

According to a tenth aspect of an embodiment of the present disclosure, there is provided a registration apparatus, including:
a processor; and
a memory configured to store instructions executable by the processor;
wherein the processor is configured to perform steps of the registration method provided in the second aspect of the present disclosure.

According to an eleventh aspect of an embodiment of the present disclosure, there is provided a registration apparatus, including:
a processor; and
a memory configured to store instructions executable by the processor;
wherein the processor is configured to perform steps of the registration method provided in the third aspect of the present disclosure.

According to a twelfth aspect of an embodiment of the present disclosure, there is provided a registration apparatus, including:
a processor; and
a memory configured to store instructions executable by the processor;
wherein the processor is configured to perform steps of the registration method provided in the fourth aspect of the present disclosure.

According to a thirteenth aspect of an embodiment of the present disclosure, there is provided a computer-readable storage medium having computer program instructions stored thereon, which, when executed by a processor, implement steps of the registration method provided in the first aspect of the present disclosure

According to a fourteenth aspect of an embodiment of the present disclosure, there is provided a computer-readable storage medium having computer program instructions stored thereon, which, when executed by a processor, implement steps of the registration method provided in the second aspect of the present disclosure.

According to a fifteenth aspect of an embodiment of the present disclosure, there is provided a computer-readable storage medium having computer program instructions stored thereon, which, when executed by a processor, implement steps of the registration method provided in the third aspect of the present disclosure.

According to the sixteenth aspect of an embodiment of the present disclosure, there is provided a computer-readable storage medium having computer program instructions stored thereon, which, when executed by a processor, implement steps of the registration method provided in the fourth aspect of the present disclosure.

According to a seventeenth aspect of an embodiment of the present disclosure, there is provided a chip, including: a processor and an interface; the processor is configured to read instructions to perform steps of the registration method provided in the first aspect of the present disclosure.

According to an eighteenth aspect of an embodiment of the present disclosure, there is provided a chip, including: a processor and an interface; the processor is configured to read instructions to perform steps of the registration method provided in the second aspect of the present disclosure.

According to the nineteenth aspect of the embodiment of the present disclosure, there is provided a chip, including: a processor and an interface; the processor is configured to read instructions to perform steps of the registration method provided in the third aspect of the present disclosure.

According to the twentieth aspect of the embodiment of the present disclosure, there is provided a chip, including: a processor and an interface; the processor is configured to read instructions to perform steps of the registration method provided in the fourth aspect of the present disclosure.

The technical solutions provided by the embodiment of the present disclosure may include the following beneficial effects: the terminal device can send the first registration request message to the first network function through the first access network device, and determine that the terminal device is successfully registered in the first communication network, in response to receiving the first registration acceptance message sent, through the first access network device, by the first network function. The first registration request message may include the first parameter, and the first parameter may be configured to characterize the registration of the terminal device with the plurality of communication networks. The communication networks may include the first communication network, and the first network function is the network function in the first communication network. The first registration acceptance message is the message sent by the first network function when it determines, according to the first registration request message, that both the terminal device and the first communication network have the capability to support the terminal device to register in the plurality of communication networks. In this way, the terminal device can register in the plurality of communication networks and maintain the registration status, thereby realizing the demand of the terminal device to use the plurality of communication networks for communication at the same time and improving the communication quality and reliability of the user.

It is to be understood that the foregoing general description and the following detailed description are illustrative and explanatory only and are not restrictive of the present disclosure.

### BRIEF DESCRIPTION OF THE DRAWINGS

The accompanying drawings, which are incorporated in and constitute a part of the specification, illustrate embodiments consistent with the present disclosure and, together with the description, serve to explain the principles of the present disclosure.

FIG. 1 is a schematic diagram showing a communication system according to an example embodiment.

FIG. 2 is a flowchart showing a registration method according to an example embodiment.

FIG. 3 is a flowchart showing a registration method according to an example embodiment.

FIG. 4 is a flowchart showing a registration method according to an example embodiment.

FIG. 5 is a flowchart showing a registration method according to an example embodiment.

FIG. 6 is a flowchart showing a registration method according to an example embodiment.

FIG. 7 is a flowchart showing a registration method according to an example embodiment.

FIG. 8 is a flowchart showing a registration method according to an example embodiment.

FIG. 9 is a flowchart showing a registration method according to an example embodiment.

FIG. 10 is a block diagram showing a registration apparatus according to an example embodiment.

FIG. 11 is a block diagram showing a registration apparatus according to an example embodiment.

FIG. 12 is a block diagram showing a registration apparatus according to an example embodiment.

FIG. 13 is a block diagram showing a registration apparatus according to an example embodiment.

FIG. 14 is a block diagram showing a registration apparatus according to an example embodiment.

FIG. 15 is a block diagram showing a registration apparatus according to an example embodiment.

### DETAILED DESCRIPTION

Example embodiments will be described in detail herein, examples of which are shown in the accompanying drawings. When the following description refers to the drawings, the same numbers in different drawings represent the same or similar elements unless otherwise indicated. The embodiments described in the following example embodiments do not represent all embodiments consistent with the present disclosure. Instead, they are merely examples of devices and methods consistent with some aspects of the present disclosure as detailed in the appended claims.

It should be noted that all actions of obtaining signals, information or data in the present disclosure are carried out in compliance with relevant data protection laws and policies of the country where a device is located and with the authorization given by the corresponding owner of the device.

The terms such as “first”, “second”, etc. used in the description of the present disclosure are used to distinguish similar objects and are not necessarily understood as a specific order or sequence. In addition, in the description with reference to the accompanying drawings, the same symbol in different drawings represents the same element unless otherwise specified.

In the description of the present disclosure, unless otherwise specified, “multiple or a plurality of” refers to two or more than two, and other quantifiers are similar. The expression “at least one”, “one or more” or similar expression refers to any combination of these items, including any combination of single or plural items. For example, at least one can represent any number; for another example, one or more of a, b or c can represent: a, b, c, a-b, a-c, b-c, or a-b-c, where a, b, c can be single or plural; “and/or” is a description of an association relationship of associated objects, indicating that three relationships may exist. For example, A and/or B can represent: A exists alone, A and B exist at the same time, and B exists alone, where A and B can be singular or plural.

Although operations or steps are described in a specific order in the drawings in embodiments of the present disclosure, it should not be understood that it is required to perform these operations or steps in the specific order shown or in a serial order, or to perform all the operations or steps shown to obtain the desired results. In the embodiments of the present disclosure, these operations or steps can be performed in series; these operations or steps can also be performed in parallel; or some of these operations or steps can be performed.

The following first introduces an implementation environment of embodiments of the present disclosure.

The technical solution of embodiments of the present disclosure can be applied to various communication systems. The communication system may include one or more of the 4th Generation (4G) communication system, the 5th Generation (5G) communication system, and other future wireless communication systems (such as 6G). The communication system may also include one or more of a Public Land Mobile Network (PLMN) network, a Device-to-Device (D2D) communication system, a Machine to Machine (M2M) communication system, an Internet of Things (IoT) communication system, a Vehicle-to-Everything (V2X) communication system or other communication systems.

FIG. 1 is a schematic diagram showing a communication system according to an example embodiment. As shown in FIG. 1, the communication system may include a terminal device 150, a communication network 160, and a third network function 171. The communication network 160 may include one or more communication networks. For example, the communication network 160 may include a first communication network 161, a second communication network 162, . . . , an Nth communication network 16N, etc. Each of the above communication networks may be used to support 4G network access technologies, such as Long Term Evolution (LTE) access technologies, or 5G network access technologies, such as New Radio Access Technology (New RAT), or other future wireless communication technologies.

Each communication network may include an access network device and a core network device. The core network device may include at least one network function. The access network device may be used to support a terminal device to access. The terminal device may be connected to the access network device wirelessly. The access network device may be connected to the core network device wirelessly and/or wiredly. The core network device and the access network device may be independent and different physical devices, or the functions of the core network device and the logical functions of the access network device may be integrated in the same physical device, or some functions of the core network device and some functions of the access network device may be integrated in one physical device.

It should be noted that the terminal device may be an electronic device that provides voice or data connectivity. For example, the terminal device may also be referred to as a User Equipment (UE), a subscriber unit, a mobile station, a station, a terminal, etc. For example, the terminal device may include a smart phone, a smart wearable device, a smart speaker, a smart tablet, a wireless modem, a Wireless Local Loop (WLL) station, a Personal Digital Assistant (PDA), a Customer Premise Equipment (CPE), etc. With the development of wireless communication technologies, devices that can access the communication system, can communicate with the access network device of the communication system, can communicate with other objects through the communication system, or can directly communicate between two or more devices can all be terminal devices in embodiments of the present disclosure, for example, terminals and cars in smart transportation, household appliances in smart homes, power meter reading instruments, voltage monitoring instruments, environmental monitoring instruments in smart grids, video monitoring instruments in smart security networks, cash registers, etc. In embodiments of the present disclosure, the terminal device may communicate with the access network device, or the terminal device may communicate with at least one network function (e.g., a first network function) of the core network device through the access network device. Multiple terminal devices may also communicate with each other. The terminal device may be static or mobile, which is not limited in the present disclosure.

The above-mentioned access network device can be used to support the terminal device to access. For example, the access network device may be an evolutional Node B (eNB or eNodeB) in LTE; the access network device may also be the next Generation Node B (gNB or gNodeB) in the 5G network; the access network device may also be a NG Radio Access Network (NG-RAN) device in the 5G network; the access network device may also be a base station in a future evolved Public Land Mobile Network (PLMN), a Broadband Network Gateway (BNG), an aggregation switch or a non-3rd Generation Partnership Project (3GPP) access device, etc. The access network device in embodiments of the present disclosure may include various forms of base stations, such as, macro base stations, micro base stations (also called small stations), relay stations, access points, 5G base stations or future base stations, satellites, Transmitting and Receiving Points (TRPs), Transmitting Points (TPs), mobile switching centers, and Device-to-Device (D2D), Machine-to-Machine (M2M), Internet of Things (IoT), Vehicle-to-Everything (V2X) or other devices that assume the function of a base station in other communications, etc., which are not specifically limited in embodiments of the present disclosure. For the convenience of description, in all embodiments of the present disclosure, devices that provide wireless communication functions for the terminal device are collectively referred to as access network devices or base stations.

In some embodiments of the present disclosure, the first communication network 161 may include a first network function 1611 and a first access network device 1612, and the first network function may be a network function in a first core network device. The second communication network 162 may include a second network function 1611 and a second access network device 1612, and the second network function may be a network function in a second core network device. Similarly, the Nth communication network 16N may include an Nth network function 16N1 and an Nth access network device 1612, and the Nth network function may be a network function in an Nth core network device. The network functions (such as the first network function, the second network function or the Nth network function) may be hardware, or may be software divided in terms of function, or a structure in which software and hardware are combined.

The first network function, the second network function and the Nth network function can all be network functions that provide the access and mobility management function, which, for example, may include a Mobility Management Entity (MME) in a 4G network, or may also include an Access and Mobility Management Function (AMF) in a 5G network, or may also include network functions that provide access and management functions or mobility management functions in other future communication networks.

The third network function may be a network function that provides a user data management function. For example, the third network function may include a Home Subscriber Server (HSS) in a 4G network, or may also include a Unified Data Management (UDM) in a 5G network, or may also include network functions that provide user data management functions in other future communication networks.

It should be noted that the number of terminal devices, communication networks and third network functions in FIG. 1 can be one or more. For example, the communication network can include only two networks, that is, the first communication network and the second communication network, or can include N communication networks, where N can be greater than 2. In addition, the communication system shown in FIG. 1 is only an example, and embodiments of the present disclosure are not limited to the system shown in FIG. 1.

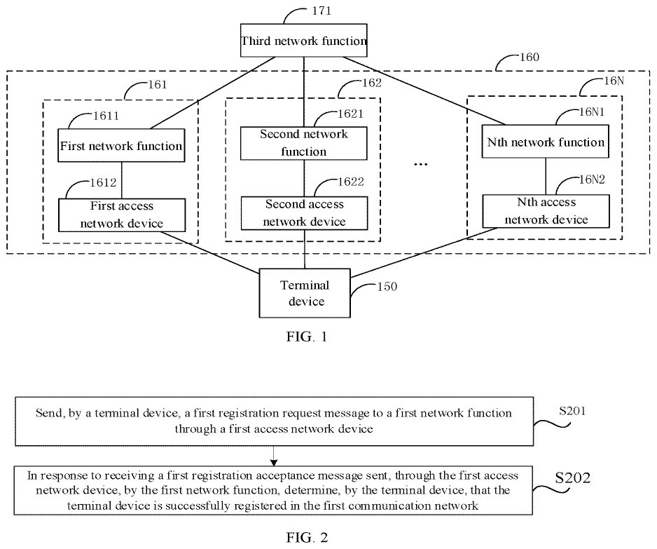

FIG. 2 is a flowchart showing a registration method according to an example embodiment. The method may be applied to the terminal device in the above communication system. As shown in FIG. 2, the method may include S201 and S202.

In S201, the terminal device sends a first registration request message to a first network function through a first access network device.

In some embodiments, the first registration request message may include a first parameter, which may be used to characterize registration of the terminal device with a plurality of communication networks (e.g., two or three communication networks). The communication network may include a first communication network, and the first network function is a network function in the first communication network.

In an implementation, the first parameter may include a registration type parameter (e.g., Registration Type), and a value of the registration type parameter may be a first type. The first type may be used to characterize the registration of the terminal device with the plurality of communication networks, and the first type may be any value pre-set or specified by a protocol. For example, the first type may be a Dual 3GPP-Access Registration, and for another example, when the first communication network is a 5G network, the first type may be a Dual 3GPP-Access Registration to the 5GS.

In another implementation, the first parameter may include a first indication parameter, which may be a newly added parameter based on the existing 3GPP protocol, or an unused reserved bit in the existing 3GPP protocol. The first indication parameter can be used to characterize the registration of the terminal device with the plurality of communication networks.

In some other embodiments, the first registration request message may include a second parameter, and the second parameter may be used to characterize that the terminal device has a capability to register with the plurality of communication networks.

In an implementation, the second parameter may include a terminal capability parameter, and a value of the terminal capability parameter may be a first capability. The first capability may be used to characterize that the terminal device has the capability to register with the plurality of communication networks, and the first capability may be any value pre-set or specified by a protocol. For example, the first capability may be supporting Dual 3GPP Access.

In another implementation, the second parameter may include a second indication parameter, which may be a newly added parameter based on the existing 3GPP protocol, or an unused reserved bit in the existing 3GPP protocol. The second indication parameter can be used to characterize that the terminal device has the capability to register with the plurality of communication networks.

In some other embodiments, the first registration request message may include the above first parameter and second parameter.

In S202, in response to receiving a first registration acceptance message sent, through the first access network device, by the first network function, the terminal device determines that the terminal device is successfully registered in the first communication network.

In some embodiments, the first registration acceptance message may be a message sent by the first network function when it determines, according to the first registration request message, that both the terminal device and the first communication network have the capability to support the terminal device to register in the plurality of communication networks.

In some other embodiments, the first registration acceptance message may be a message sent by the first network function when it, according to the first registration request message, determines that both the terminal device and the first communication network have the capability to support the terminal device to register in the plurality of communication networks, and determines that the terminal device has successfully registered in the first communication network.

In some embodiments, the first network function may determine, by exchanging messages with the third network function, whether both the terminal device and the first communication network have the capability to support the terminal device to register in the plurality of communication networks.

In some other embodiments, the first network function may also determine on its own whether the terminal device and the first communication network both have the capability to support the terminal device to register in the plurality of communication networks. The first network function may determine, based on a first network parameter, whether the first communication network has the capability to support the terminal device to register in the plurality of communication networks, and the first network parameter may be a pre-configured parameter. The first network function may also determine, based on the first parameter and/or the second parameter, whether the terminal device has the capability to register in the plurality of communication networks.

For example, in some embodiments, when the first registration request message includes the first parameter, the first network function may determine that the terminal device has the capability to register in the plurality of communication networks.

In some other embodiments, when the first registration request message includes the first parameter (registration type parameter) and the value of the first parameter is the first type, the first network function can determine that the terminal device has the capability to register in the plurality of communication networks.

In some other embodiments, when the first registration request message includes the second parameter, the first network function may determine that the terminal device has the capability to register in the plurality of communication networks.

In some further embodiments, when the first registration request message includes the second parameter and the value of the second parameter is the first capability, the first network function can determine that the terminal device has the capability to register in the plurality of communication networks.

In some embodiments, the first network function may be a network function in a core network device that provides access and mobility management functions, such as an AMF in a 5G core network device.

By way of example, the first network function may be a first Access and Mobility Management Function (AMF).

It should be noted that the terminal device can send the first registration request message (e.g., Registration request) to the first network function through the first access network device through the access network device, and can also receive, through the access network device, the first registration acceptance message (e.g., Registration Accept) sent by the first network function.

By adopting the above method, the terminal device can send the first registration request message to the first network function through the first access network device, and determine that the terminal device is successfully registered in the first communication network, in response to receiving the first registration acceptance message sent, through the first access network device, by the first network function. The first registration request message may include the first parameter, and the first parameter may be configured to characterize the registration of the terminal device with the plurality of communication networks. The communication networks may include the first communication network, and the first network function is the network function in the first communication network. The first registration acceptance message is the message sent by the first network function when it determines, according to the first registration request message, that both the terminal device and the first communication network have the capability to support the terminal device to register in the plurality of communication networks. In this way, the terminal device can register in the plurality of communication networks and maintain the registration status, thereby realizing the demand of the terminal device to use the plurality of communication networks for communication at the same time and improving the communication quality and reliability of the user.

In some embodiments of the present disclosure, the terminal device may register with the first communication network and a second communication network, respectively.

In an implementation, the terminal device may register in the first communication network and the second communication network in parallel. For example, the terminal device may send the first registration request message to the first network function in the first communication network, and send a second registration request message to a second network function in the second communication network.

In another implementation, the terminal device may register in the first communication network and the second communication network in series. For example, the terminal device may first register in the second communication network and then register in the first communication network.

For example, when the terminal device is successfully registered with the second communication network, the terminal device may send the first registration request message to the first network function through the first access network device.

For another example, after the terminal device initiates registration with the second communication network, regardless of whether the registration succeeds or fails, the terminal device can send the first registration request message to the first network function through the first access network device.

In this way, the terminal device can register in both the first communication network and the second communication network and maintain a registration success status, thereby meeting the demand that the terminal device simultaneously uses the first communication network and the second communication network for communication.

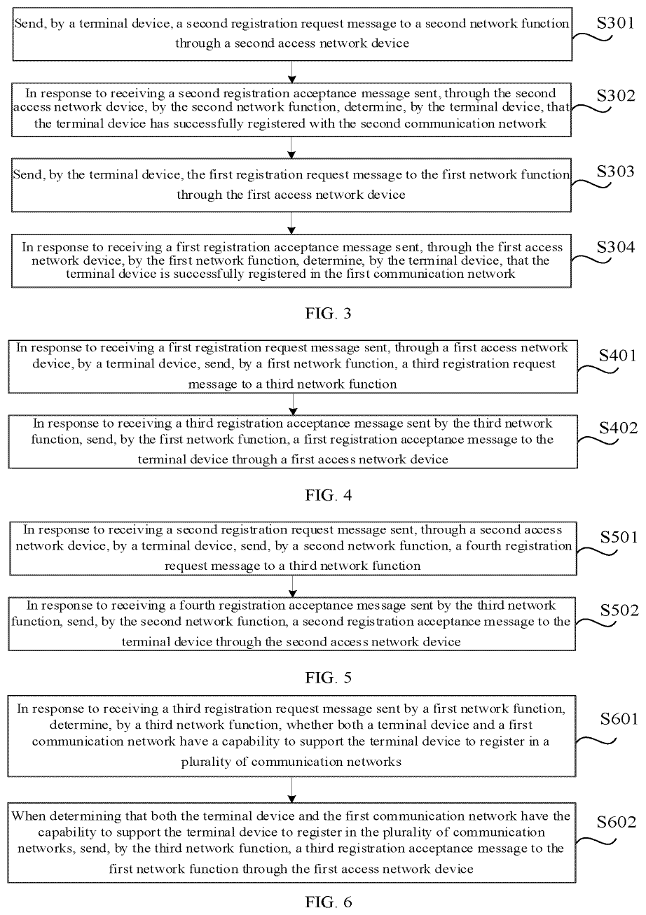

FIG. 3 is a flowchart showing a registration method according to an example embodiment. As shown in FIG. 3, the method may include S301 to S304.

In S301, the terminal device sends a second registration request message to a second network function through a second access network device.

In some embodiments, the second registration request message may include the above-mentioned second parameter, which may be used to characterize that the terminal device has the capability to register with the plurality of communication networks. The communication networks may include a first communication network and a second communication network, and the second network function is a network function in the second communication network.

In some other embodiments, the second registration request message may include the above-mentioned first parameter.

In some other embodiments, the second registration request message may include the above-mentioned first parameter and second parameter.

In some further embodiments, the second registration request message may not include the above-mentioned first parameter and second parameter.

In S302, in response to receiving a second registration acceptance message sent, through the second access network device, by the second network function, the terminal device determines that the terminal device has successfully registered with the second communication network.

In S303, the terminal device sends the first registration request message to the first network function through the first access network device.

In some embodiments, the first registration request message may include the above-mentioned first parameter and/or second parameter.

In S304, in response to receiving the first registration acceptance message sent, through the first access network device, by the first network function, the terminal device determines that the terminal device has successfully registered in the first communication network.

In this way, the terminal device can register in both the first communication network and the second communication network and maintain the registration success status.

In some embodiments, the above-mentioned steps S301 and S303 can be performed in parallel, so that the terminal device can register in two communication networks at the same time. The parameter types included in the above-mentioned first registration request message and second registration request message can be the same. For example, the first registration request message and the second registration request message can both include the first parameter, or the first registration request message and the second registration request message can both include the second parameter, or the first registration request message and the second registration request message can both include the first parameter and the second parameter.

In some other embodiments, the above steps may be executed in series. For example, when the terminal device determines that the registration with the second communication network is successful, the terminal device executes the step S303.

The parameter types included in the above-mentioned first registration request message and second registration request message can be the same or different. For example, the first registration request message may include the second parameter but not the first parameter, and the second registration request message may include the first parameter but not the second parameter.

In some embodiments of the present disclosure, when the terminal device determines that a target network has a capability to support the terminal device to register in the plurality of communication networks, it may send the first registration request message to the first network function through the first access network device.

The target network may be the first communication network, or the target network may be the second communication network, or the target network may include the first communication network and the second communication network.

In some embodiments of the present disclosure, the second registration acceptance message may include a target network capability parameter, which is used to characterize whether the target network has the capability to support the terminal device to register in the plurality of communication networks, and the target network includes the first communication network and/or the second communication network.

In this way, the terminal device can determine, based on the target network capability parameter, whether the target network has the capability to support the terminal device to register in the plurality of communication networks; when the terminal device determines that the target network has the capability to support the terminal device to register in the plurality of communication networks, it can send the first registration request message to the first network function through the first access network device; conversely, when the terminal device determines that the target network does not have this capability, it may not initiate registration with the first communication network.

By way of example, the target network capability parameter may include one or more of a first network capability parameter and a second network capability parameter, the first network capability parameter is configured to characterize whether the first communication network has the capability to support the terminal device to register in the plurality of communication networks, and the second network capability parameter is configured to characterize whether the second communication network has the capability to support the terminal device to register in the plurality of communication networks.

In an implementation, the target network capability parameter may include a correspondence between a network identification identifier and a network capability, and the network identification identifier may include one or more of a Cell Global Identification (CGI), a Tracking Area ID (TAI), a Radio Access Type (RAT), a Public Land Mobile Network Identification (PLMN ID). Taking the network identification identifier as the PLMN ID as an example, a PLMN ID corresponding to the first communication network may be 1, and the corresponding network capability is the first network capability (the capability to support the terminal device to register in the plurality of communication networks). The PLMN ID corresponding to the first communication network may be 2, and the corresponding network capability is the second network capability (the capability to also support the terminal device to register in the plurality of communication networks).

In this way, the terminal device can determine the capability of the target network based on the received target network capability parameter, and when the terminal device determines that the target network has the capability to support the terminal device to register in the plurality of communication networks, it sends the first registration request message to the first network function through the first access network device.

In some embodiments, the first registration acceptance message may also include the target network capability parameter.

In some embodiments, the first network function may be a first Access and Mobility Management Function (AMF), and the second network function may be a second AMF.

It should be noted that, in some embodiments, the first AMF and the second AMF may be the same AMF, and in some other embodiments, the first AMF and the second AMF may be different AMFs, which is not limited in the present disclosure.

In some embodiments, the terminal device may send the first registration request message to the first network function through the first access network device, and may also receive, through the first access network device, the first registration acceptance message sent by the first network function. Similarly, the terminal device may send the second registration request message to the second network function through the second access network device, and may also receive, through the second access network device, the second registration acceptance message sent by the second network function. The first access network device and the second access network device may be the same or different, and the first network function and the second network function may be the same or different, which is not limited by the present disclosure.

In some embodiments of the present disclosure, the plurality of communication networks may all be 3GPP networks.

For example, in some embodiments, the first communication network and the second communication network may have the same network identifier or different network identifiers. The network identifier may be the PLMN ID.

In some embodiments, the first communication network and the second communication network may have the same network type or different network types. The network type may be RAT.

For example, the first communication network may be a network with the PLMN ID being 1 and the RAT being LTE/EPC, and the second communication network may be a network with the PLMN ID being 1 and the RAT being NR/5GC.

For another example, the first communication network may be a network with the PLMN ID being 1 and the RAT being NR/5GC, and the second communication network may be a network with the PLMN ID being 2 and the RAT being NR/5GC.

For another example, the first communication network may be a network with the PLMN ID being 1 and the RAT being LTE/EPC, and the second communication network may be a network with the PLMN ID being 2 and the RAT being NR/5GC.

For another example, the first communication network may be a network with the PLMN ID being 1 and the RAT being NTN, and the second communication network may be a network with the PLMN ID being 1 and the RAT being TN.

In this way, the terminal device can register in different combinations of the first communication network and the second communication network and maintain the registration status.

In some embodiments, signals from the first communication network and the second communication network can be received in a location where the terminal device is located.

The terminal device may have the capability to register in the plurality of communication networks, or have the capability to communicate in the plurality of communication networks.

For example, the terminal device may have a dual 3GPP-RAT (Radio Access Type) capability, and the first communication network and the second communication network are both 3GPP networks.

For example, the dual 3GPP-RAT may include the NR and the LTE, the first communication network may be an NR network, and the second communication network may be an LTE network; or vice versa.

For another example, the dual 3GPP-RAT may also include a Non-Terrestrial Network (NTN) and a Terrestrial Network (TN), the first communication network may be an NTN network, and the second communication network may be a TN network.

For another example, the dual 3GPP-RAT may both be NR, and the first communication network and the second communication network may both be NR networks.

The terminal device may report, through the first registration request message, the network standards it supports. For example, the terminal device may indicate, through the second parameter, the network standards it supports.

In this way, the terminal device can register in both the first communication network and the second communication network within a capability support range.

In some embodiments of the present disclosure, the plurality of communication networks are all 3GPP networks. The 3GPP network may include an NR network and/or an LTE network, and the 3GPP network may also include an NTN network and/or a TN network.

In some embodiments of the present disclosure, the first registration request message may further include one or more of a terminal identification parameter, a terminal capability parameter, and a security parameter.

The terminal identification parameter may include one or more of a Subscription Concealed Identifier (SUCI), a Subscriber Permanent Identifier (SUPI), a Globally Unique Temporary Identifier (GUTI), and a Permanent Equipment Identifier (PEI). The GUTI may be a 5G-GUTI, a 4G-GUTI, or a GUTI under another network standard, which is not limited by the present disclosure,

The terminal capability parameter may be used to characterize a UE capability supported by the terminal device. In an implementation, the second parameter may be a sub-parameter in the terminal capability parameter.

Similarly, the second registration request message may also include one or more of the terminal identification parameter, the terminal capability parameter and the security parameter.

In an implementation, the first registration request message and the second registration request message may include the same terminal identification parameter, and the terminal identification parameter is an identity corresponding to the terminal device.

In this way, the terminal device can implement the registration through parameters in the first registration request message and/or the second registration request message to perform communication.

FIG. 4 is a flowchart showing a registration method according to an example embodiment. The method may be applied to the first network function in the above communication system. As shown in FIG. 4, the method may include S401 and S402.

In S401, in response to receiving a first registration request message sent, through a first access network device, by a terminal device, the first network function sends a third registration request message to a third network function.

In some embodiments, the first registration request message and the third registration request message may both include a first parameter, and the first parameter may be used to characterize registration of the terminal device with a plurality of communication networks. The communication network may include a first communication network, the first network function is a network function in the first communication network, and the third network function is a network function that provides a user data management function. It should be noted that the third network function may be a network function in the first communication network, or a network function independent of the first communication network.

In an implementation, the first parameter may include a registration type parameter (e.g., Registration Type), and a value of the registration type parameter may be a first type. The first type may be used to characterize the registration of the terminal device with the plurality of communication networks.

In some other embodiments, the first registration request message and the third registration request message may both include a second parameter, and the second parameter may be used to characterize that the terminal device has a capability to register with the plurality of communication networks, and the communication network may also include a second communication network.

In some other embodiments, the first registration request message may include the first parameter and the second parameter, and the third registration request message may also include the first parameter and the second parameter.

In S402, in response to receiving a third registration acceptance message sent by the third network function, the first network function sends a first registration acceptance message to the terminal device through a first access network device.

The first registration acceptance message is used to indicate that the terminal device has successfully registered in the first communication network.

In some embodiments, the third registration acceptance message is a message sent by the third network function when it determines, based on the third registration request message, that both the terminal device and the first communication network have the capability to support the terminal device to register in the plurality of communication networks.

In some other embodiments, the third registration acceptance message may be a message sent by the third network function when it, based on the third registration request message, determines that both the terminal device and the first communication network have the capability to support the terminal device to register in the plurality of communication networks, and determines that the terminal device has successfully registered in the first communication network.

By adopting the above method, the first network function can support the terminal device to register in the plurality of communication networks and maintain the registration status, thereby realizing the demand of the terminal device to use the plurality of communication networks for communication at the same time and improving the communication quality and reliability of the user.

In some embodiments, the third network function may determine whether both the terminal device and the first communication network have the capability to support the terminal device to register in the plurality of communication networks in the following manner:
first, the third network function may determine, according to a third network parameter, whether the first communication network has the capability to support the terminal device to register in the plurality of communication networks. The third network parameter may be a pre-configured parameter; and
secondly, the third network function may also determine, according to the first parameter and/or the second parameter, whether the terminal device has the capability to register in the plurality of communication networks.

In some embodiments, when the third registration request message includes the first parameter, the third network function may determine that the terminal device has the capability to register in the plurality of communication networks.

In some other embodiments, when the third registration request message includes the first parameter (registration type parameter) and a value of the first parameter is a first type, the third network function can determine that the terminal device has the capability to register in the plurality of communication networks.

In some other embodiments, when the third registration request message includes the second parameter, the third network function may determine that the terminal device has the capability to register in the plurality of communication networks.

In some further embodiments, when the third registration request message includes the second parameter and a value of the second parameter is a first capability, the third network function can determine that the terminal device has the capability to register in the plurality of communication networks.

In this way, the third network function can determine whether the terminal device and the first communication network both have the capability to support the terminal device to register in the plurality of communication networks.

In some embodiments of the present disclosure, the third registration request message may further include a first network type and/or a first network identifier corresponding to the first communication network.

The third network function may determine, based on the first network type and/or the first network identifier, whether the first communication network has the capability to support the terminal device to register in the plurality of communication networks.

For example, the third network function may be pre-configured with at least one first network type which has the capability to support the terminal device to register in the plurality of communication networks, or may also be pre-configured with at least one first network identifier which has the capability to support the terminal device to register in the plurality of communication networks. In this way, the third network function may determine, based on the first network type and/or the first network identifier, whether the first communication network has the capability to support the terminal device to register in the plurality of communication networks.

The first network type may be a RAT Type (e.g., 3G, 4G, or 5G) corresponding to the first communication network, and the first network identifier may be a PLMN ID corresponding to the first communication network.

Furthermore, the third network function may also determine, according to the first network type and/or the first network identifier, whether the terminal device is successfully registered in the first communication network. If the registration is successful, the third network function sends the third registration acceptance message to the first network function through the first access network device.

In some embodiments, the first registration acceptance message may include a target network capability parameter, which is used to characterize whether a target network has the capability to support the terminal device to register in the plurality of communication networks, and the target network includes the first communication network and/or the second communication network.

In some embodiments, the first network function may be a first Access and Mobility Management Function (AMF), and the third network function may be a Unified Data Management (UDM).

In some embodiments of the present disclosure, the plurality of communication networks are all 3GPP networks. For example, the 3GPP network may include an NR network and/or an LTE network, and the 3GPP network may also include an NTN network and/or a TN network.

FIG. 5 is a flowchart showing a registration method according to an example embodiment. The method may be applied to the second network function in the above communication system. As shown in FIG. 5, the method may include S501 and S502.

In S501, in response to receiving a second registration request message sent, through a second access network device, by a terminal device, the second network function sends a fourth registration request message to a third network function.

In some embodiments, the second registration request message and the fourth registration request message may both include a second parameter, which may be used to characterize that the terminal device has a capability to register with a plurality of communication networks. The communication network includes a first communication network and a second communication network, and the second network function is a network function in the second communication network.

In some other embodiments, the second registration request message and the fourth registration request message may both include a first parameter, which may be used to characterize registration of the terminal device with the plurality of communication networks. The communication network may also include a first communication network, which may include a first network function.

In some other embodiments, the second registration request message and the fourth registration request message may both include the first parameter and the second parameter.

In some further embodiments, the second registration request message and the fourth registration request message may not include the first parameter and the second parameter.

In S502, in response to receiving a fourth registration acceptance message sent by the third network function, the second network function sends a second registration acceptance message to the terminal device through the second access network device.

The second registration acceptance message is used to indicate that the terminal device has successfully registered in the second communication network, so that when the terminal device is successfully registered with the second communication network, it sends a first registration request message to a first network function through a first access network device. The first registration request message includes a first parameter, and the first parameter is configured to characterize the registration of the terminal device with the plurality of communication networks, and the first network function is a network function in the first communication network.

By adopting the above method, the second network function can support the terminal device to register in the plurality of communication networks and maintain the registration status, thereby realizing the demand of the terminal device to use the plurality of communication networks for communication at the same time and improving the communication quality and reliability of the user.

In some embodiments of the present disclosure, the fourth registration request message may further include a second network type and/or a second network identifier corresponding to the second communication network.

The third network function may determine, according to the second network type and/or the second network identifier, whether the terminal device is successfully registered in the second communication network.

In some embodiments of the present disclosure, the second registration acceptance message may include a target network capability parameter, which is used to characterize whether the target network has the capability to support the terminal device to register in the plurality of communication networks, and the target network includes the first communication network and/or the second communication network.

In some embodiments of the present disclosure, the first network function may be a first AMF, the second network function may be a second AMF, and the third network function may be a Unified Data Management (UDM).

In some embodiments of the present disclosure, the plurality of communication networks may all be 3GPP networks.

FIG. 6 is a flowchart showing a registration method according to an example embodiment. The method may be applied to the third network function in the above communication system. As shown in FIG. 6, the method may include S601 and S602.

In S601, in response to receiving a third registration request message sent by a first network function, a third network function determines whether both a terminal device and a first communication network have a capability to support the terminal device to register in a plurality of communication networks.

The third registration request message is a message sent by a first network function to the third network function in response to receiving a first registration request message sent, through a first access network device, by the terminal device.

In some embodiments, the first registration request message and the third registration request message both include a first parameter, and the first parameter is configured to characterize registration of the terminal device with the plurality of communication networks. The communication network includes a first communication network, and the first network function is a network function in the first communication network.

In some other embodiments, the first registration request message and the third registration request message may both include a second parameter, and the second parameter may be used to characterize that the terminal device has a capability to register with the plurality of communication networks.

In some other embodiments, the first registration request message may include the first parameter and the second parameter, and the third registration request message may also include the first parameter and the second parameter.

In S602, when determining that both the terminal device and the first communication network have the capability to support the terminal device to register in the plurality of communication networks, the third network function sends a third registration acceptance message to the first network function through the first access network device.

The third registration acceptance message is used to instruct the first network function to send, through the first access network device, a first registration acceptance message to the terminal device, and the first registration acceptance message is used to indicate that the terminal device has successfully registered in the first communication network.

By adopting the above method, the third network function can support the terminal device to register in the plurality of communication networks and maintain the registration status, thereby realizing the demand of the terminal device to use the plurality of communication networks for communication at the same time and improving the communication quality and reliability of the user.

In some embodiments, the third network function may determine whether both the terminal device and the first communication network have the capability to support the terminal device to register in the plurality of communication networks in the following manner:
first, the third network function may determine, according to a third network parameter, whether the first communication network has the capability to support the terminal device to register in the plurality of communication networks. The third network parameter may be a pre-configured parameter; and
secondly, the third network function may also determine, according to the first parameter and/or the second parameter, whether the terminal device has the capability to register in the plurality of communication networks.

In some embodiments, when the third registration request message includes the first parameter, the third network function may determine that the terminal device has the capability to register in the plurality of communication networks.

In some other embodiments, when the third registration request message includes the first parameter (registration type parameter) and a value of the first parameter is a first type, the third network function can determine that the terminal device has the capability to register in the plurality of communication networks.

In some other embodiments, when the third registration request message includes the second parameter, the third network function may determine that the terminal device has the capability to register in the plurality of communication networks.

In some further embodiments, when the third registration request message includes the second parameter and a value of the second parameter is a first capability, the third network function can determine that the terminal device has the capability to register in the plurality of communication networks.

In this way, the third network function can determine whether the terminal device and the first communication network both have the capability to support the terminal device to register in the plurality of communication networks.

In some embodiments of the present disclosure, the third registration request message may further include a first network type and/or a first network identifier corresponding to the first communication network.

The third network function may determine, based on the first network type and/or the first network identifier, whether the first communication network has the capability to support the terminal device to register in the plurality of communication networks.

For example, the third network function may be pre-configured with at least one first network type which has the capability to support the terminal device to register in the plurality of communication networks, or may also be pre-configured with at least one first network identifier which has the capability to support the terminal device to register in the plurality of communication networks. In this way, the third network function may determine, based on the first network type and/or the first network identifier, whether the first communication network has the capability to support the terminal device to register in the plurality of communication networks.

The first network type may be a RAT Type (e.g., 3G, 4G, or 5G) corresponding to the first communication network, and the first network identifier may be a PLMN ID corresponding to the first communication network.

Furthermore, the third network function may also determine, according to the first network type and/or the first network identifier, whether the terminal device is successfully registered in the first communication network. If the registration is successful, the third network function sends the third registration acceptance message to the first network function through the first access network device.

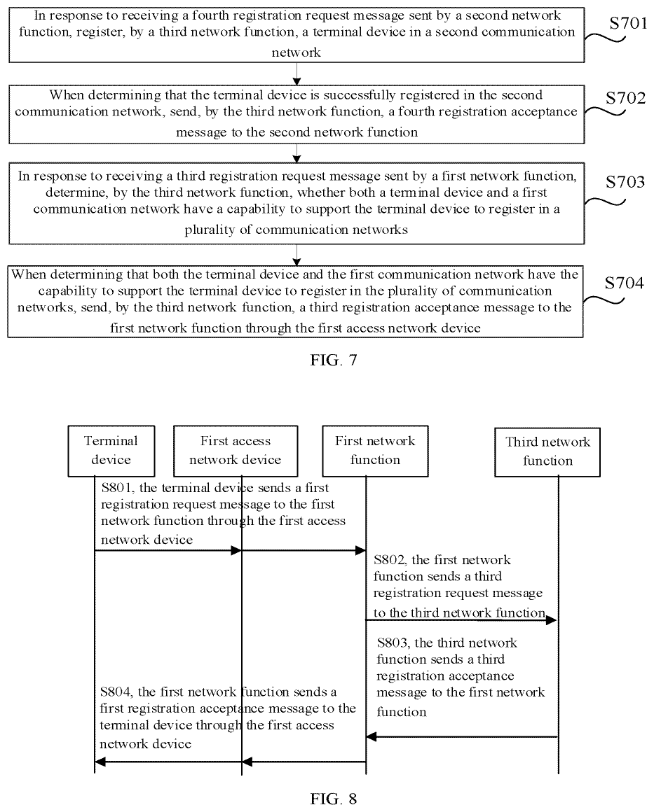

FIG. 7 is a flowchart showing a registration method according to an example embodiment. As shown in FIG. 7, the method may include S701 to S704.

In S701, in response to receiving a fourth registration request message sent by a second network function, the third network function registers a terminal device in a second communication network.

The fourth registration request message is a message sent by the second network function to the third network function in response to receiving a second registration request message sent, through a second access network device, by the terminal device.

In some embodiments, the second registration request message and the fourth registration request message both include a second parameter, and the second parameter is configured to characterize that the terminal device has the capability to register with the plurality of communication networks. The communication network includes a first communication network and a second communication network, and the second network function is a network function in the second communication network.

In some other embodiments, the second registration request message and the fourth registration request message may both include a first parameter, which may be used to characterize the registration of the terminal device with the plurality of communication networks. The communication network may also include the first communication network, which may include the first network function.

In some other embodiments, the second registration request message and the fourth registration request message may both include the first parameter and the second parameter.

In some further embodiments, the second registration request message and the fourth registration request message may not include the first parameter and the second parameter.

In S702, when determining that the terminal device is successfully registered in the second communication network, the third network function sends a fourth registration acceptance message to the second network function.

The fourth registration acceptance message may be used to instruct the second network function to send, through the second access network device, the second registration acceptance message to the terminal device. The second registration acceptance message may be used to indicate that the terminal device has successfully registered in the second communication network, so that when the terminal device is successfully registered with the second communication network, it sends a first registration request message to a first network function through a first access network device. The first registration request message includes a first parameter, and the first parameter is configured to characterize the registration of the terminal device with the plurality of communication networks, and the first network function is a network function in the first communication network.

In S703, in response to receiving a third registration request message sent by a first network function, the third network function determines whether both the terminal device and the first communication network have the capability to support the terminal device to register in the plurality of communication networks.

In S704, when determining that both the terminal device and the first communication network have the capability to support the terminal device to register in the plurality of communication networks, the third network function sends a third registration acceptance message to the first network function through the first access network device.

By adopting the above method, the third network function can support the terminal device to register in both the first communication network and the second communication network and maintain the registration status.

In some embodiments of the present disclosure, the fourth registration request message may further include a second network type and/or a second network identifier corresponding to the second communication network.

The third network function may determine, according to the second network type and/or the second network identifier, whether the terminal device is successfully registered in the second communication network.

In some embodiments of the present disclosure, the first network function may be a first Access and Mobility Management Function (AMF), the second network function may be a second AMF, and the third network function may be a Unified Data Management (UDM).

In some embodiments of the present disclosure, the plurality of communication networks are all 3GPP networks. For example, the 3GPP network may include an NR network and/or an LTE network, and the 3GPP network may also include an NTN network and/or a TN network.

FIG. 8 is a flowchart showing a registration method according to an example embodiment. As shown in FIG. 8, the method may include S801 to S804.

In S801, the terminal device sends a first registration request message to the first network function through the first access network device.

The first registration request message may include the above-mentioned first parameter and/or second parameter.

In S802, the first network function sends a third registration request message to the third network function.

For example, in response to receiving the first registration request message sent, through the first access network device, by the terminal device, the first network function may send the third registration request message to the third network function.

In some embodiments, the third registration request message may include the above-mentioned first parameter and/or second parameter.

In S803, the third network function sends a third registration acceptance message to the first network function.

For example, in response to receiving the third registration request message sent by the first network function, the third network function determines whether the terminal device and the first communication network both have the capability to support the terminal device to register in the plurality of communication networks, and when the third network function determines that the terminal device and the first communication network both have the capability to support the terminal device to register in the plurality of communication networks, it sends the third registration acceptance message to the first network function through the first access network device.

In S804, the first network function sends a first registration acceptance message to the terminal device through the first access network device.

For example, in response to receiving the third registration acceptance message sent by the third network function, the first network function sends the first registration acceptance message to the terminal device through the first access network device.

In some embodiments, in response to receiving the first registration acceptance message sent, through the first access network device, by the first network function, the terminal device can determine that the terminal device has successfully registered in the first communication network.

In some embodiments, the first network function may be a first Access and Mobility Management Function (AMF), the second network function may be a second AMF, and the third network function may be a Unified Data Management (UDM).

In some embodiments, the terminal device may send the first registration request message to the first network function through the first access network device, and may also receive, through the first access network device, the first registration acceptance message sent by the first network function.

In some embodiments, the plurality of communication networks are all 3GPP networks. For example, the 3GPP network may include an NR network and/or an LTE network, and the 3GPP network may also include an NTN network and/or a TN network.

It should be noted that the specific implementation of the above steps in the embodiment can refer to the description in the previous embodiments of the present disclosure, which will not be repeated here.

In this way, the terminal device can register in the plurality of communication networks and maintain the registration status, thereby realizing the demand of the terminal device to use the plurality of communication networks for communication at the same time and improving the communication quality and reliability of the user.

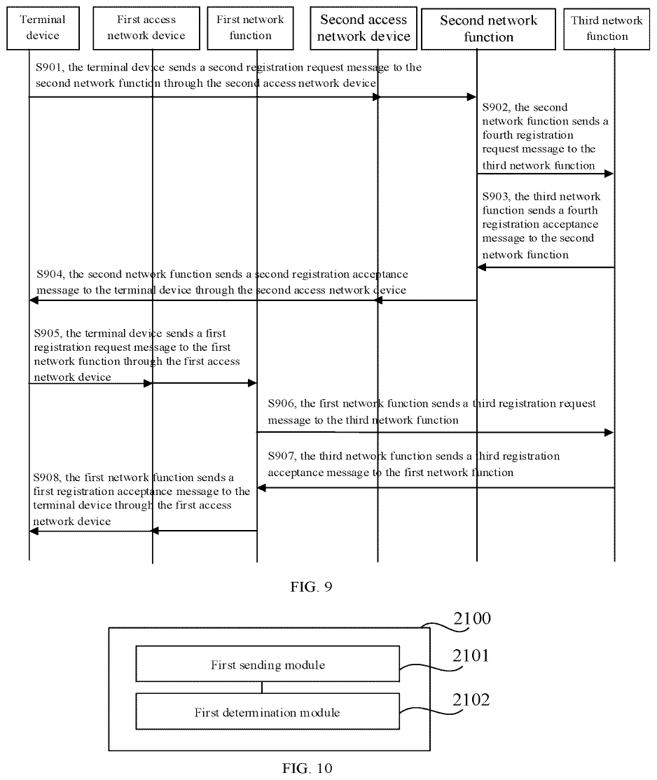

FIG. 9 is a flowchart showing a registration method according to an example embodiment. As shown in FIG. 9, the method may include S901 to S908

In S901, the terminal device sends a second registration request message to the second network function through the second access network device.

In some embodiments, the second registration request message may include the above-mentioned first parameter and/or second parameter.

In some embodiments, the second registration request message may not include the first parameter and the second parameter.

In S902, the second network function sends a fourth registration request message to the third network function.

For example, in response to receiving the second registration request message sent, through the second access network device, by the terminal device, the second network function may send the fourth registration request message to the third network function.

In some embodiments, the fourth registration request message may include the first parameter and/or the second parameter.

In some embodiments, the fourth registration request message may not include the first parameter and the second parameter.

In S903, the third network function sends a fourth registration acceptance message to the second network function.

For example, in response to receiving the fourth registration request message sent by the second network function, the third network function may register the terminal device in the second communication network, and when the third network function determines that the terminal device has successfully registered in the second communication network, it may send the fourth registration acceptance message to the second network function.

In S904, the second network function sends a second registration acceptance message to the terminal device through the second access network device.

For example, in response to receiving the fourth registration acceptance message sent by the third network function, the second network function may send the second registration acceptance message to the terminal device through the second access network device.

In this way, in response to receiving the second registration acceptance message sent, through the second access network device, by the second network function, the terminal device can determine that the terminal device has successfully registered with the second communication network.

In S905, the terminal device sends a first registration request message to the first network function through the first access network device.

In some embodiments, the first registration request message may include the above-mentioned first parameter and/or second parameter.

In S906, the first network function sends a third registration request message to the third network function.

For example, in response to receiving the first registration request message sent, through the first access network device, by the terminal device, the first network function may send the third registration request message to the third network function.

In some embodiments, the third registration request message may include the above-mentioned first parameter and/or second parameter.

In S907, the third network function sends a third registration acceptance message to the first network function.

For example, in response to receiving the third registration request message sent by the first network function, the third network function determines whether the terminal device and the first communication network both have the capability to support the terminal device to register in the plurality of communication networks, and when the third network function determines the terminal device and the first communication network both have the capability to support the terminal device to register in the plurality of communication networks, it sends the third registration acceptance message to the first network function.

In S908, the first network function sends a first registration acceptance message to the terminal device through the first access network device.

For example, in response to receiving the third registration acceptance message sent by the third network function, the first network function sends the first registration acceptance message to the terminal device through the first access network device.

In some embodiments, in response to receiving the first registration acceptance message sent, through the first access network device, by the first network function, the terminal device can determine that the terminal device has successfully registered in the first communication network.

In some embodiments, the first network function may be a first Access and Mobility Management Function (AMF), the second network function may be a second AMF, and the third network function may be a Unified Data Management (UDM).

In some embodiments, the terminal device may send the first registration request message to the first network function through the first access network device, and may also receive, through the first access network device, the first registration acceptance message sent by the first network function. Similarly, the terminal device may send the second registration request message to the second network function through the second access network device, and may also receive, through the second access network device, the second registration acceptance message sent by the second network function. The first access network device and the second access network device may be the same or different, and the first network function and the second network function may be the same or different, which is not limited by the present disclosure.

In some embodiments, the plurality of communication networks are all 3GPP networks. For example, the 3GPP network may include an NR network and/or an LTE network, and the 3GPP network may also include an NTN network and/or a TN network.

It should be noted that the specific implementation of the above steps in the embodiment can refer to the description in the previous embodiments of the present disclosure, which will not be repeated here.

In this way, the terminal device can register in both the first communication network and the second communication network and maintain the registration success status.

FIG. 10 is a block diagram showing a registration apparatus 2100 according to an example embodiment. The apparatus may be applied to a terminal device. As shown in FIG. 10, the apparatus 2100 may include:
a first sending module 2101, configured to send a first registration request message to a first network function through a first access network device, wherein the first registration request message includes a first parameter, the first parameter is configured to characterize registration of the terminal device with a plurality of communication networks, the communication networks include a first communication network, and the first network function is a network function in the first communication network; and
a first determination module 2102, configured to, in response to receiving a first registration acceptance message sent, through the first access network device, by the first network function, determine that the terminal device is successfully registered in the first communication network, wherein the first registration acceptance message is a message sent by the first network function in a case of determining, according to the first registration request message, that the terminal device and the first communication network have a capability to support the terminal device to register in the plurality of communication networks.

In some embodiments, the first parameter is a registration type parameter, and a value of the registration type parameter is a first type.

In some embodiments, the first sending module 2101 is configured to, in a case where the terminal device is successfully registered with a second communication network, send the first registration request message to the first network function.

In some embodiments, the first sending module 2101 is configured to send a second registration request message to a second network function through a second access network device, wherein the second registration request message includes a second parameter, the second parameter is configured to characterize that the terminal device has a capability to register with the plurality of communication networks, the communication networks further include the second communication network, and the second network function is a network function in the second communication network; and in response to receiving a second registration acceptance message sent, through the second access network device, by the second network function, determine that the terminal device is successfully registered with the second communication network.

In some embodiments, the second registration acceptance message includes a target network capability parameter, the target network capability parameter is configured to characterize whether a target network has the capability to support the terminal device to register in the plurality of communication networks, the target network includes the first communication network and/or the second communication network; and the first sending module 2101 is configured to send the first registration request message to the first network function in a case of determining that the target network has the capability to support the terminal device to register in the plurality of communication networks.

In some embodiments, the first registration acceptance message includes the target network capability parameter.

In some embodiments, the first registration request message further includes the second parameter.

In some embodiments, the first registration request message and the second registration request message include the same terminal identification parameter, and the terminal identification parameter is an identity corresponding to the terminal device.

In some embodiments, the first network function is a first Access and Mobility Management Function (AMF), and the second network function is a second AMF.

In some embodiments, the plurality of communication networks are all 3GPP networks.

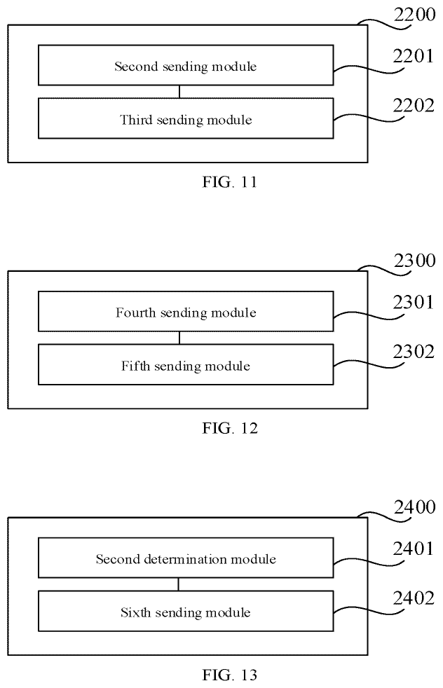

FIG. 11 is a block diagram showing a registration apparatus 2200 according to an example embodiment. The apparatus may be applied to a first network function. As shown in FIG. 11, the apparatus 2200 may include:
a second sending module 2201, configured to, in response to receiving a first registration request message sent, through a first access network device, by a terminal device, send a third registration request message to a third network function, wherein the first registration request message and the third registration request message include a first parameter, the first parameter is configured to characterize registration of the terminal device with a plurality of communication networks, the communication networks include a first communication network, the first network function is a network function in the first communication network, and the third network function is a network function that provides a user data management function; and
a third sending module 2202, configured to, in response to receiving a third registration acceptance message sent by the third network function, send a first registration acceptance message to the terminal device through the first access network device, the first registration acceptance message is configured to indicate that the terminal device has successfully registered in the first communication network, and the third registration acceptance message is a message sent by the third network function when it determines, based on the third registration request message, that both the terminal device and the first communication network have the capability to support the terminal device to register in the plurality of communication networks.

In some embodiments, the third registration request message further includes a first network type and/or a first network identifier corresponding to the first communication network.

In some embodiments, the first registration request message and the third registration request message further include a second parameter, the second parameter is configured to characterize that the terminal device has a capability to register with the plurality of communication networks, and the communication networks further include a second communication network.

In some embodiments, the first registration acceptance message includes a target network capability parameter, and the target network capability parameter is configured to characterize whether a target network has a capability to support the terminal device to register in the plurality of communication networks, and the target network includes the first communication network and/or the second communication network.

In some embodiments, the first network function is a first Access and Mobility Management Function (AMF), and the third network function is a unified data management (UDM).

In some embodiments, the plurality of communication networks are all 3GPP networks.

FIG. 12 is a block diagram showing a registration apparatus 2300 according to an example embodiment. The device may be applied to a second network function. As shown in FIG. 12, the apparatus 2300 may include:
a fourth sending module 2301, configured to, in response to receiving a second registration request message sent, through a second access network device, by a terminal device, send a fourth registration request message to a third network function, wherein the second registration request message and the fourth registration request message include a second parameter, the second parameter is configured to characterize that the terminal device has a capability to register with a plurality of communication networks, the communication networks include a first communication network and a second communication network, and the second network function is a network function in the second communication network; and
a fifth sending module 2302, configured to, in response to receiving a fourth registration acceptance message sent by the third network function, send a second registration acceptance message to the terminal device through the second access network device, the second registration acceptance message is used to indicate that the terminal device has successfully registered in the second communication network, so that when the terminal device is successfully registered with the second communication network, it sends a first registration request message to a first network function through a first access network device; and the first registration request message includes a first parameter, and the first parameter is configured to characterize the registration of the terminal device with the plurality of communication networks, and the first network function is a network function in the first communication network.

In some embodiments, the fourth registration request message further includes a second network type and/or a second network identifier corresponding to the second communication network.

In some embodiments, the second registration request message and the fourth registration request message also include the first parameter.

In some embodiments, the second registration acceptance message includes a target network capability parameter, and the target network capability parameter is configured to characterize whether a target network has a capability to support the terminal device to register in the plurality of communication networks, and the target network includes the first communication network and/or the second communication network.

In some embodiments, the first network function is a first Access and Mobility Management Function (AMF), the second network function is a second AMF, and the third network function is a Unified Data Management (UDM).

In some embodiments, the plurality of communication networks are all 3GPP networks.

FIG. 13 is a block diagram showing a registration apparatus 2400 according to an example embodiment. The apparatus may be applied to a third network function. As shown in FIG. 13, the apparatus 2400 may include:
a second determination module 2401, configured to, in response to receiving a third registration request message sent by a first network function, determine whether a terminal device and a first communication network have a capability to support the terminal device to register in a plurality of communication networks, wherein the third registration request message is a message sent by a first network function to the third network function in response to receiving a first registration request message sent, through a first access network device, by the terminal device, the first registration request message and the third registration request message include a first parameter, the first parameter is configured to characterize registration of the terminal device with the plurality of communication networks, the communication networks include the first communication network, and the first network function is a network function in the first communication network; and
a sixth sending module 2402, configured to send a third registration acceptance message to the first network function in a case of determining that the terminal device and the first communication network have the capability to support the terminal device to register in the plurality of communication networks, the third registration acceptance message is used to instruct the first network function to send, through the first access network device, a first registration acceptance message to the terminal device, and the first registration acceptance message is used to indicate that the terminal device has successfully registered in the first communication network.

In some embodiments, the third registration request message further includes a first network type and/or a first network identifier corresponding to the first communication network.

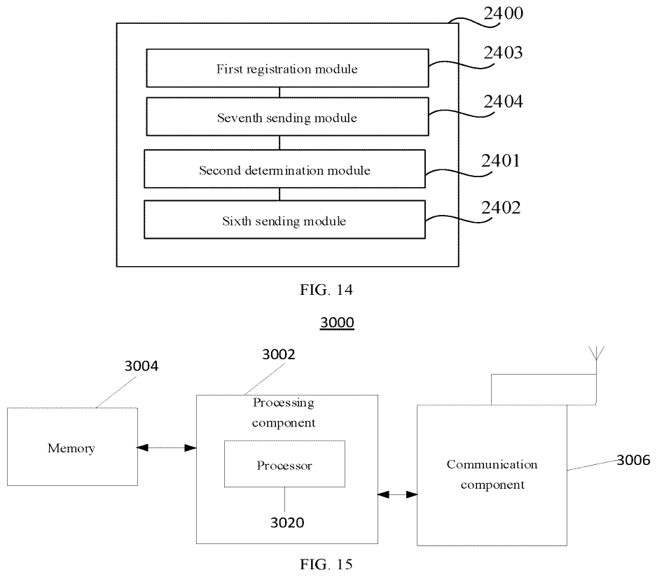

FIG. 14 is a block diagram showing a registration apparatus 2400 according to an example embodiment. As shown in FIG. 14, the apparatus 2400 may also include:
a first registration module 2403, configured to, in response to receiving a fourth registration request message sent by a second network function, register the terminal device in a second communication network, the fourth registration request message is a message sent by the second network function to the third network function in response to receiving a second registration request message sent, through a second access network device, by the terminal device, the second registration request message and the fourth registration request message includes a second parameter, the second parameter is configured to characterize that the terminal device has a capability to register with the plurality of communication networks, the communication networks include the first communication network and the second communication network, and the second network function is a network function in the second communication network; and
a seventh sending module 2404, configured to send a fourth registration acceptance message to the second network function in a case of determining that the terminal device is successfully registered in the second communication network, the fourth registration acceptance message is used to instruct the second network function to send, through the second access network device, a second registration acceptance message to the terminal device, and the second registration acceptance message is used to indicate that the terminal device has successfully registered in the second communication network, so that when the terminal device is successfully registered with the second communication network, it sends a first registration request message to a first network function through a first access network device, the first registration request message includes a first parameter, and the first parameter is configured to characterize the registration of the terminal device with the plurality of communication networks, and the first network function is a network function in the first communication network.

In some embodiments, the fourth registration request message further includes a second network type and/or a second network identifier corresponding to the second communication network.

In some embodiments, the second registration request message and the fourth registration request message also include the first parameter.

In some embodiments, both the first registration request message and the third registration request message further include the second parameter.

In some embodiments, the first network function is a first Access and Mobility Management Function (AMF), the second network function is a second AMF, and the third network function is a Unified Data Management (UDM).

In some embodiments, the plurality of communication networks are all 3GPP networks.

Regarding the apparatus in the above embodiments, the specific manner in which each module performs operations has been described in detail in the embodiments of the methods, and will not be elaborated here.

FIG. 15 is a block diagram showing a registration apparatus according to an example embodiment. The registration apparatus 3000 may be the terminal device, the first network function, the second network function or the third network function in the communication system shown in FIG. 1.

Referring to FIG. 15, the apparatus 3000 may include one or more of the following components: a processing component 3002, a memory 3004, and a communication component 3006.

The processing component 3002 may be configured to control overall operations of the apparatus 3000, such as the operations associated with display, telephone calls, data communications, camera operations, and recording operations. The processing component 3002 may include one or more processors 3020 to execute instructions to perform all or part of the steps in the above described registration methods. Moreover, the processing component 3002 may include one or more modules which facilitate the interaction between the processing component 3002 and other components. For instance, the processing component 3002 may include a multimedia module to facilitate the interaction between the multimedia component and the processing component 3002.

The memory 3004 is configured to store various types of data to support the operation of the apparatus 3000. Examples of such data include instructions for any applications or methods operated on the apparatus 3000, contact data, phonebook data, messages, pictures, video, etc. The memory 3004 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The communication component 3006 is configured to facilitate communication, wired or wirelessly, between the apparatus 3000 and other devices. The apparatus 3000 can access a wireless network based on a communication standard, such as Wi-Fi, 2G, 3G, 4G, 5G, 6G, NB-IOT, eMTC, etc., or a combination thereof. In one example embodiment, the apparatus 3000 receives a broadcast signal or broadcast associated information from an external broadcast management system via a broadcast channel. In one example embodiment, the communication component 3006 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the apparatus 3000 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described registration methods.

In addition to being an independent electronic device, the above described apparatus 3000 can also be a part of an independent electronic device. For example, in one embodiment, the electronic device can be an Integrated Circuit (IC) or a chip, and the integrated circuit can be an IC or a collection of multiple ICs. The chip can include but is not limited to the following types: Graphics Processing Unit (GPU), Central Processing Unit (CPU), Field Programmable Gate Array (FPGA), Digital Signal Processor (DSP), Application Specific Integrated Circuit (ASIC), System on Chip (SoC, or system level chip), etc. The above described integrated circuit or chip can be used to execute executable instructions (or codes) to implement the above described registration methods. The executable instructions can be stored in the integrated circuit or chip, or can be obtained from other devices or equipment, for example, the integrated circuit or chip includes a processor, a memory, and an interface for communicating with other device(s). The executable instructions can be stored in the processor, and when the executable instructions are executed by the processor, the above described registration methods are implemented. Alternatively, the integrated circuit or chip may receive the executable instructions through the interface and transmit them to the processor for execution, so as to implement the above described registration methods.

In example embodiments, the present disclosure further provides a computer-readable storage medium having computer program instructions stored thereon, which, when executed by a processor, implement steps of the registration method provided by the present disclosure. By way of example, the computer-readable storage medium may be a non-transitory computer-readable storage medium including instructions, such as the memory 3004 including instructions executable by the processor 3020 in the apparatus 3000, for performing the above-described registration methods. For example, the non-transitory computer-readable storage medium may be a ROM, a Random Access Memory (RAM), a CD-ROM, a magnetic tape, a floppy disc, an optical data storage device, and the like.

In another example embodiment, a computer program product is also provided. The computer program product includes a computer program executable by a programmable apparatus, and the computer program has a code portion for executing the above registration methods when executed by the programmable apparatus.

Other embodiments of the present disclosure will be apparent to those skilled in the art from consideration of the specification and practice of the disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A registration method, applied to a terminal device, and comprising:
sending a first registration request message to a first network function through a first access network device, wherein the first registration request message comprises a first parameter, the first parameter is configured to characterize registration of the terminal device with a plurality of communication networks, the communication networks comprise a first communication network, and the first network function is a network function in the first communication network; and
in response to receiving a first registration acceptance message sent, through the first access network device, by the first network function, determining that the terminal device is successfully registered in the first communication network, wherein the first registration acceptance message is a message sent by the first network function in a case of determining, according to the first registration request message, that the terminal device and the first communication network have a capability to support the terminal device to register in the plurality of communication networks.

2. The method according to claim 1, wherein the first parameter is a registration type parameter, and a value of the registration type parameter is a first type.

3. The method according to claim 1, wherein sending the first registration request message to the first network function through the first access network device comprises:
in a case where the terminal device is successfully registered with a second communication network, sending the first registration request message to the first network function.

4. The method according to claim 3, wherein the terminal device is registered with the second communication network in the following manner:
sending a second registration request message to a second network function through a second access network device, wherein the second registration request message comprises a second parameter, the second parameter is configured to characterize that the terminal device has a capability to register with the plurality of communication networks, the communication networks further comprise the second communication network, and the second network function is a network function in the second communication network; and
in response to receiving a second registration acceptance message sent, through the second access network device, by the second network function, determining that the terminal device is successfully registered with the second communication network.

5. The method according to claim 4, wherein the second registration acceptance message comprises a target network capability parameter, the target network capability parameter is configured to characterize whether a target network has the capability to support the terminal device to register in the plurality of communication networks, the target network comprises the first communication network and/or the second communication network; and
sending the first registration request message to the first network function comprises:
sending the first registration request message to the first network function in a case of determining that the target network has the capability to support the terminal device to register in the plurality of communication networks.

6. The method according to claim 5, wherein the first registration acceptance message comprises the target network capability parameter.

7. The method according to claim 4, wherein the first registration request message further comprises the second parameter.

8. The method according to claim 4, wherein the first registration request message and the second registration request message comprise the same terminal identification parameter, and the terminal identification parameter is an identity corresponding to the terminal device.

9. The method according to claim 4, wherein the first network function is a first Access and Mobility Management Function (AMF), and the second network function is a second AMF.

10. The method according to any one of claims 1 to 9, wherein the plurality of communication networks are all 3GPP networks.

11. A registration method, applied to a first network function, and comprising:
in response to receiving a first registration request message sent, through a first access network device, by a terminal device, sending a third registration request message to a third network function, wherein the first registration request message and the third registration request message comprise a first parameter, the first parameter is configured to characterize registration of the terminal device with a plurality of communication networks, the communication networks comprise a first communication network, the first network function is a network function in the first communication network, and the third network function is a network function that provides a user data management function; and
in response to receiving a third registration acceptance message sent by the third network function, sending a first registration acceptance message to the terminal device through the first access network device.

12. The method according to claim 11, wherein the third registration request message further comprises a first network type and/or a first network identifier corresponding to the first communication network.

13. The method according to claim 11, wherein the first registration request message and the third registration request message further comprise a second parameter, the second parameter is configured to characterize that the terminal device has a capability to register with the plurality of communication networks, and the communication networks further comprise a second communication network.

14. The method according to claim 13, wherein the first registration acceptance message comprises a target network capability parameter, and the target network capability parameter is configured to characterize whether a target network has a capability to support the terminal device to register in the plurality of communication networks, and the target network comprises the first communication network and/or the second communication network.

15. The method according to claim 11, wherein the first network function is a first Access and Mobility Management Function (AMF), and the third network function is a unified data management (UDM).

16. The method according to any one of claims 11 to 15, wherein the plurality of communication networks are all 3GPP networks.

17. A registration method, applied to a second network function, and comprising:
in response to receiving a second registration request message sent, through a second access network device, by a terminal device, sending a fourth registration request message to a third network function, wherein the second registration request message and the fourth registration request message comprise a second parameter, the second parameter is configured to characterize that the terminal device has a capability to register with a plurality of communication networks, the communication networks comprise a first communication network and a second communication network, and the second network function is a network function in the second communication network; and
in response to receiving a fourth registration acceptance message sent by the third network function, sending a second registration acceptance message to the terminal device through the second access network device.

18. The method according to claim 17, wherein the fourth registration request message further comprises a second network type and/or a second network identifier corresponding to the second communication network.

19. The method according to claim 17, wherein the second registration request message and the fourth registration request message further comprise a first parameter, and the first parameter is configured to characterize registration of the terminal device with the plurality of communication networks.

20. The method according to claim 17, wherein the second registration acceptance message comprises a target network capability parameter, and the target network capability parameter is configured to characterize whether a target network has a capability to support the terminal device to register in the plurality of communication networks, and the target network comprises the first communication network and/or the second communication network.

21. The method according to claim 17, wherein the second network function is a second AMF, and the third network function is a Unified Data Management (UDM).

22. The method according to any one of claims 17 to 21, wherein the plurality of communication networks are all 3GPP networks.

23. A registration method, applied to a third network function, and comprising:
in response to receiving a third registration request message sent by a first network function, determining whether a terminal device and a first communication network have a capability to support the terminal device to register in a plurality of communication networks, wherein the third registration request message comprises a first parameter, the first parameter is configured to characterize registration of the terminal device with the plurality of communication networks, the communication networks comprise the first communication network, and the first network function is a network function in the first communication network; and
sending a third registration acceptance message to the first network function in a case of determining that the terminal device and the first communication network have the capability to support the terminal device to register in the plurality of communication networks.

24. The method according to claim 23, wherein the third registration request message further comprises a first network type and/or a first network identifier corresponding to the first communication network.

25. The method according to claim 23, wherein the method further comprises:
in response to receiving a fourth registration request message sent by a second network function, registering the terminal device in a second communication network, wherein the fourth registration request message comprises a second parameter, the second parameter is configured to characterize that the terminal device has a capability to register with the plurality of communication networks, the communication networks comprise the first communication network and the second communication network, and the second network function is a network function in the second communication network; and
sending a fourth registration acceptance message to the second network function in a case of determining that the terminal device is successfully registered in the second communication network.

26. The method according to claim 25, wherein the fourth registration request message further comprises a second network type and/or a second network identifier corresponding to the second communication network.

27. The method according to claim 25, wherein the fourth registration request message further comprises the first parameter.

28. The method according to claim 25, wherein the third registration request message further comprises the second parameter.

29. The method according to claim 25, wherein the first network function is a first Access and Mobility Management Function (AMF), the second network function is a second AMF, and the third network function is a Unified Data Management (UDM).

30. The method according to any one of claims 23 to 29, wherein the plurality of communication networks are all 3GPP networks.

31. A registration apparatus, applied to a terminal device and comprising:
a first sending module, configured to send a first registration request message to a first network function through a first access network device, wherein the first registration request message comprises a first parameter, the first parameter is configured to characterize registration of the terminal device with a plurality of communication networks, the communication networks comprise a first communication network, and the first network function is a network function in the first communication network; and
a first determination module, configured to, in response to receiving a first registration acceptance message sent, through the first access network device, by the first network function, determine that the terminal device is successfully registered in the first communication network, wherein the first registration acceptance message is a message sent by the first network function in a case of determining, according to the first registration request message, that the terminal device and the first communication network have a capability to support the terminal device to register in the plurality of communication networks.

32. A registration apparatus, applied to a first network function, and comprising:
a second sending module, configured to, in response to receiving a first registration request message sent, through a first access network device, by a terminal device, send a third registration request message to a third network function, wherein the first registration request message and the third registration request message comprise a first parameter, the first parameter is configured to characterize registration of the terminal device with a plurality of communication networks, the communication networks comprise a first communication network, the first network function is a network function in the first communication network, and the third network function is a network function that provides a user data management function; and
a third sending module, configured to, in response to receiving a third registration acceptance message sent by the third network function, send a first registration acceptance message to the terminal device through the first access network device.

33. A registration apparatus, applied to a second network function, and comprising:
a fourth sending module, configured to, in response to receiving a second registration request message sent, through a second access network device, by a terminal device, send a fourth registration request message to a third network function, wherein the second registration request message and the fourth registration request message comprise a second parameter, the second parameter is configured to characterize that the terminal device has a capability to register with a plurality of communication networks, the communication networks comprise a first communication network and a second communication network, and the second network function is a network function in the second communication network; and
a fifth sending module, configured to, in response to receiving a fourth registration acceptance message sent by the third network function, send a second registration acceptance message to the terminal device through the second access network device.

34. A registration apparatus, applied to a third network function, and comprising:
a second determination module, configured to, in response to receiving a third registration request message sent by a first network function, determine whether a terminal device and a first communication network have a capability to support the terminal device to register in a plurality of communication networks, wherein the third registration request message comprises a first parameter, the first parameter is configured to characterize registration of the terminal device with the plurality of communication networks, the communication networks comprise the first communication network, and the first network function is a network function in the first communication network; and
a sixth sending module, configured to send a third registration acceptance message to the first network function in a case of determining that the terminal device and the first communication network have the capability to support the terminal device to register in the plurality of communication networks.

35. A registration apparatus, comprising:
a processor; and
a memory configured to store instructions executable by the processor;
wherein the processor is configured to perform steps of the method according to any one of claims 1 to 10, or the processor is configured to perform steps of the method according to any one of claims 11 to 16, or the processor is configured to perform steps of the method according to any one of claims 17 to 22, or the processor is configured to perform steps of the method according to any one of claims 23 to 30.

36. A computer-readable storage medium having computer program instructions stored thereon, which, when executed by a processor, implement steps of the method according to any one of claims 1 to 10, or implement steps of the method according to any one of claims 11 to 16, or implement steps of the method according to any one of claims 17 to 22, or implement steps of the method according to any one of claims 23 to 30.

37. A chip, comprising: a processor and an interface; the processor is configured to read instructions to perform steps of the method according to any one of claims 1 to 10, or the processor is configured to read instructions to perform steps of the method according to any one of claims 11 to 16, or the processor is configured to read instructions to perform steps of the method according to any one of claims 17 to 22, or the processor is configured to read instructions to perform steps of the method according to any one of claims 23 to 30.
